(19) United States
(12) Patent Application Publication
(10) Pub. No.: US 2021/0131126 A1
(43) Pub. Date: May 6, 2021

(54) Descaling apparatus for steel tubes of the building scaffold

(71) Applicant: Qianhan Zhuang, Wenzhou City (CN)

(72) Inventor: Qianhan Zhuang, Wenzhou City (CN)

(21) Appl. No.: 17/149,751

(22) Filed: Jan. 15, 2021

(30) Foreign Application Priority Data
Feb. 26, 2020 (CN) 2020101179048

(51) Int. Cl. E04G 5/00; B24B 47/12; B24B 27/033

(52) U.S. Cl. CPC E04G 5/005; B24B 27/033; B24B 47/12

(57) ABSTRACT

This invention discloses a descaling apparatus for steel tubes of the building scaffold, belonging to the technical field of construction equipment, which solves the existing problems with low quality in rust-removal of the steel tube of the building scaffold, and the descaling apparatus for steel tubes of the building scaffold comprises a bottom panel (1), a working table (11), a pushing base (2) on the bottom panel (1) along a length direction, several of forward rust-scraping rings (3) and several of reverse rust-scraping rings (4) on the working table (11), several of forward scrapers (33) on the forward rust-scraping rings (3), several of reverse scrapers (43) on the reverse rust-scraping rings (4), a driving member on the working table (11), several sets of rolling assemblies (5) on the working table (11); this invention has a better rust-removal effect and is more labor-saving when in manual operation.

### CROSS-REFERENCES TO RELATED APPLICATIONS

The present application claims priority from Japanese application No. 2020-126966 filed on Jul. 28, 2020 which is hereby incorporated by reference in its entirety.

### TECHNICAL FIELD

The present invention relates to the technical field of construction equipment, in particular to a descaling apparatus for steel tubes of the building scaffold.

### BACKGROUND OF THE INVENTION

Scaffolds are a working platform to ensure a smooth construction. They are divided into outer scaffold and inner scaffold according to set positions or wood scaffold, bamboo scaffold and steel tube scaffold in terms of materials. The scaffold is not only safe and reliable for construction, but also convenient to assembly and dis-assembly. However, due to the environment that the scaffolds are in rain and sun after setting up, it is easy to get rusty after a long time using of the steel tube scaffold, and the rusted scaffold will cause a loose buckle connection as the rust flakes easily, so there is a potential safety hazard and it required people to remove the rust on the scaffold. At present, the existing rust-removal way is by manual operation, which is low in efficiency, waste time and energy with a poor rust-removal quality.

### BRIEF SUMMARY OF THE INVENTION

The technical problem to be solved by the invention is to provide a descaling apparatus for steel tubes of the building scaffold that will make the rust-removal effect better and more energy-saving with manual operation, so as to overcome the problems existing in the prior art.

The following technical plan is adopted by the invention to solve the above-mentioned technical problems: a descaling apparatus for steel tubes of the building scaffold, comprises a bottom panel extending in an elongate form and a working table fixed on one end of the bottom panel, wherein a pushing base for clamping one end of a locating steel tube is slidably arranged on the bottom panel along a length direction, and several of forward rust-scraping rings and several of reverse rust-scraping rings are rotatably connected on the working table, wherein several of the forward rust-scraping rings and several of the reverse rust-scraping rings are in radial arrangement successively along the length direction of the bottom panel, and several of the forward rust-scraping rings are disposed to be coaxial with several of the reverse rust-scraping rings, wherein several of forward scrapers are arranged on circumferences of inner side surfaces of the forward rust-scraping rings and several of reverse scrapers are arranged on circumferences of inner side surfaces of the reverse rust-scraping rings, wherein one end of each of the forward scrapers and the reverse scrapers are in the radially inward direction and inner end edges of the forward scrapers and the reverse scrapers are cutting edges, and a length direction of the cutting edges of the forward scrapers is inclined to another side relative to center lines of the forward rust-scraping rings, and a length direction of the cutting edges of the reverse scrapers is inclined to another side relative to a center line of the reverse rust-scraping rings, and a driving member for driving several of the forward rust-scraping rings and several of the reverse rust-scraping rings to rotate reversely and synchronously is arranged on the working table, wherein several sets of rolling assemblies are disposed on the working table, wherein each set of the rolling assemblies comprises at least two of rolling wheels for abutting against and supporting lower parts of the steel tubes and at least two of the rolling wheels for pressing upper parts of the steel tubes.

Whereby when rust removal is performed, one end of the steel tube is fixed on the pushing base and another end is placed on the rolling wheels along the length direction of the bottom panel, and at this time, another end of the steel tube is in aligned with inner holes of the forward rust-scraping rings and the reverse rust-scraping rings, and then the driving member drives the forward rust-scraping rings and the reverse rust-scraping rings to rotate reversely and synchronously, and at the same time, the pushing base is pushed manually to make another end of the steel tube to penetrate through several of the forward rust-scraping rings and the reverse rust-scraping rings, and then the cutting edges of the forward scrapers and the reverse scrapers are all abutted against an outer side surface of the steel tube, and then the forward rust-scraping rings and the reverse rust-scraping rings rotate to make the forward scrapers and the reverse scrapers to remove rust on the outer side surface of the steel tube, wherein the rolling wheels of the rolling assemblies are able to crush relative larger rust on the outer side surface of the steel tube, so that the forward scrapers and the reverse scrapers are able to perform following operation; as the forward scrapers and the reverse scrapers are scrap the rust of the steel tube in opposite directions, so the rust on the outer side surface of the steel tube can be scraped down with repeated movement, which achieve a better rust-removing effect, and as the rotation directions of the forward rust-scraping rings and the reverse rust-scraping rings are opposite, so reverse force acting in the circumferential direction to the steel tube from the forward scrapers and the reverse scrapers are produced, so that the above-stated circumferential forces can cancel each other out to avoid a phenomenon of circumferential rotation for the steel tube when rust-removal is performed; at the same time, the steel tube is pushed manually and the forward scrapers and the reverse scrapers are arranged inclined with opposite directions, so under a circumstance that the rotation direction of the forward rust-scraping rings and the reverse rust-scraping rings are opposite to each other, the forward scrapers and the reverse scrapers are able to produce axial force components in same direction to the steel tube, and then the axial force components will push the steel tube to make the material pushing manually more easy and labor-saving.

In above-stated descaling apparatus for steel tubes of the building scaffold, wherein a first elastic member for making the forward scrapers have a inward protruding tendency is arranged between the forward rust-scraping rings and several of the forward scrapers, and second elastic member for making the reverse scrapers have a inward protruding tendency is arranged between the reverse rust-scraping rings and several of the reverse scrapers, wherein ends of the cutting edges of several of the forward scrapers and the cutting edges of several of the reverse scrapers facing towards the pushing base are arranged with arc-shaped chamfer, and several sets of the rolling assemblies, several of the forward rust-scraping rings and several of the reverse rust-scraping rings are arranged successively at intervals; whereby the first elastic member drives the forward scrapers to press tightly to abut against an outer peripheral surface of the steel tube, and the second elastic member drives the reverse scrapers to press tightly to abut against the outer peripheral surface of the steel tube, and the arc-shaped chamfer will press the forward scrapers and the reverse scrapers more smoothly when driving the ends of the steel tube to penetrate, and several sets of the rolling assemblies, several of the forward rust-scraping rings and several of the reverse rust-scraping rings are arranged successively at intervals, which has a better rust-removal effect.

In above-stated descaling apparatus for steel tubes of the building scaffold, wherein the forward rust-scraping rings are in hollow structure, and several of the first breaches extending in the elongate form are defined on inner side surfaces of the forward rust-scraping rings on circumferential direction, wherein several of the forward scrapers extend out of several of the first breaches respectively, and several sets of first guiding columns are fixed on side walls of inner cavities of the forward rust-scraping rings, wherein several sets of the first guiding columns are corresponded to several of the forward scrapers, and first guiding sleeves are arranged on edges of two sides of the forward scrapers, wherein two of the first guiding sleeves are respectively slidably sleeved on two of the first guiding columns, wherein the first elastic member is pretensioned springs sleeved on the first guiding columns, and one end of each of the pretensioned springs is abutted against a side wall of an inner cavity of corresponding one of the forward rust-scraping rings and another end of each of the pretensioned springs is abutted against end surface of corresponding one of the first guiding sleeves to make the forward scrapers to maintain a stable state.

In above-stated descaling apparatus for steel tubes of the building scaffold, wherein the reverse rust-scraping rings are in hollow structure, several of second breaches extending in the elongate form are defined on an inner side surfaces of the reverse rust-scraping rings on circumferential direction, wherein several of the reverse scrapers extend out of several of the second breaches respectively, and several sets of guiding columns are fixed on side walls of an inner cavities of the reverse rust-scraping rings, wherein several sets of the guiding columns are corresponding to several of the reverse scrapers, wherein second guiding sleeves are arranged on edges of two sides of the reverse scrapers, wherein two of the second guiding sleeves are respectively and slidably sleeved on two of the guiding columns, wherein the second elastic member is pretensioned springs sleeved on the guiding columns, wherein one end of each of the pretensioned springs is abutted against the side wall of the cavity of corresponding one of the reverse rust-scraping rings and another end of each of the pretensioned springs is abutted against the end surface of corresponding one of the second guiding sleeves to make the reverse scrapers to maintain a stable state.

In above-stated descaling apparatus for steel tubes of the building scaffold, wherein several sets of supporting bases on bar plate shape are fixed on the working table, wherein the supporting bases on arc-shaped and cross sections of the supporting bases are on U-shaped, and two of the supporting bases of the same pair have opposite notches, and several of rolling columns are rotatably connected on bottom surfaces of the supporting bases, wherein length directions of the rolling columns are the same as that of the bottom panel, and the forward rust-scraping rings and the reverse rust-scraping rings are respectively embedded into several sets of the supporting bases, and outer side surfaces of the forward rust-scraping rings and the reverse rust-scraping rings are respectively abutted against peripheral surfaces of several of the rolling columns, and the supporting bases are able to guide and support the forward rust-scraping rings and the reverse rust-scraping rings to ensure a smooth rotation.

In above-stated descaling apparatus for steel tubes of the building scaffold, wherein the driving member comprises a drive motor, a transmission shaft and an intermediate shaft are rotatably connected on the working table, wherein the transmission shaft and the intermediate shaft are arranged along the length direction of the bottom panel, wherein several of first driving gears and several of the second driving gears are fixed on the transmission shaft along the length direction, wherein several of the first driving gears and several of the second driving gears are arranged at intervals, and several of intermediate gears are fixed on the intermediate shaft, and forward ring gears are fixed on the end surfaces of the forward rust-scraping rings, and the reverse ring gears are fixed on the end surfaces of the reverse rust-scraping rings, wherein several of the first driving gears are engaged with several of the forward ring gears, and each of the second driving gears and the corresponding one of the reverse ring gears are arranged in axially staggered relation, wherein several of the second driving gears are engaged with several of the intermediate gears, and each of the intermediate gears is engaged with the corresponding one of the reverse ring gears, and a driving pulley is fixed on a motor shaft of the drive motor, and a driven pulley is fixed on the transmission shaft, wherein the driving pulley is connected with the driven pulley by a belt, and the transmission shaft drives the forward rust-scraping rings to rotate forwardly through a cooperation of the first driving gears and the forward ring gears, and a thickness of the intermediate gears is twice as thick as that of the second driving gears and the reverse ring gears, so that the intermediate gears can be engaged with the second driving gears and the reverse ring gears at the same time; whereby the transmission shaft drives the reverse rust-scraping rings to rotate reversely through the second driving gears, the intermediate gears and the reverse ring gears.

In above-stated descaling apparatus for steel tubes of the building scaffold, wherein the rolling assemblies further comprise upper brackets and lower brackets, wherein the lower brackets are fixed on the working table, wherein two of the rolling wheels are rotatably connected on the lower brackets through pin shafts, wherein two of the pin shafts are perpendicular to the length direction of the bottom panel, and a distance between two of the pin shafts are becoming larger gradually with height, lifting brackets are slidably and vertically connected on the working table, wherein upper brackets are fixed on the lifting brackets, and two of the rolling wheels are rotatably connected on the upper brackets through the pin shafts, wherein two of the rolling wheels are perpendicular to the length direction of the bottom panel, and a distance between two of the pin shafts are becoming larger gradually with height, and two of the rolling wheels below are performing a supporting function to the steel tube while two of the rolling wheels above are performing a pressing function, and so that four of the rolling wheels are able to crush the outer side surface of the steel tube.

In above-stated descaling apparatus for steel tubes of the building scaffold, wherein supporting brackets are fixed on the working table, wherein several of guiding holes are defined on the supporting brackets, and several of guiding rods are vertically fixed on upper side surfaces of lifting brackets, wherein several of the guiding rods are slide upward respectively to pass through several of the guiding holes, wherein each of pressed springs is sleeved on each of the guiding rods, and upper ends of the pressed springs act on lower side surfaces of the supporting brackets while lower ends of the pressed springs act on the upper side surfaces of the lifting brackets, and tightening plates are hinged on edges of two sides of the supporting brackets, wherein tightening projections are arranged on side surfaces of free ends of the tightening plates, wherein locating surfaces of flat and guiding surfaces of arc-shaped are respectively disposed on the tightening projections; whereby the tightening plates swing downward to push the lifting brackets by the guiding surfaces, and then when the tightening plates are vertically downward, the locating surfaces are able to stick to and abutted against lower side surfaces of the lifting brackets; the pressed springs are able to drive the rolling wheels to press tightly on the peripheral surface of the steel tube, and after the rust-removal is finished, the tightening plates swing downward, and then the guiding surfaces on the tightening projections are able to push the lifting brackets upward until the locating surfaces are horizontally and abutted against the lower side surfaces of the lifting brackets, so that two of the rolling wheels on top separate from the steel tube for a convenient loading and unloading of the steel tube; several of rolling ledges of annular are arranged on wheel surfaces of the rolling wheels on the circumferential direction.

In above-stated descaling apparatus for steel tubes of the building scaffold, wherein several of rolling ledges of annular are arranged on wheel surfaces of the rolling wheels on the circumferential direction, wherein several of the rolling ledges are in a radial arrangement successively along the axial direction, and cross sections of the rolling ledges are on angle shape, wherein the rolling ledges are able to better crush the rust on outer side surface of the steel tube, so that the rust are crushed into pieces or peeled off to improve a rust-removal effect.

In above-stated descaling apparatus for steel tubes of the building scaffold, wherein the pushing base comprises the base and a pushing panel vertically fixed on the base, wherein a plate surface of the pushing panel is arranged along the length direction of the bottom panel, and two of clamping hoops for clamping the steel tubes are disposed on an upper edge of the pushing panel, and two of guiding grooves are fixed on one side surface of the bottom panel along the length direction, wherein the guiding grooves with opposite openings are disposed on one opposite side of two of guiding rails, and several of rollers are hinged on two side edges of the base, and the rollers on two sides are respectively arranged in two of the guiding grooves to ensure a smooth and labor-saving material pushing.

Accordingly from the above, the present invention has the following advantages:

1. As wherein the rolling wheels of the rolling assemblies are able to crush relative larger rust on the outer side surface of the steel tube, so that the forward scrapers and the reverse scrapers are able to perform following operation; as the forward scrapers and the reverse scrapers are scrap the rust of the steel tube in opposite directions, so the rust on the outer side surface of the steel tube can be scraped down with repeated movement, which achieve a better rust-removing effect.

2. As the rotation directions of the forward rust-scraping rings and the reverse rust-scraping rings are opposite, so reverse force acting in the circumferential direction to the steel tube from the forward scrapers and the reverse scrapers are produced, so that the above-stated circumferential forces can cancel each other out to avoid a phenomenon of circumferential rotation for the steel tube when rust-removal is performed.

3. As the forward scrapers and the reverse scrapers are arranged inclined with opposite directions, so under a circumstance that the rotation direction of the forward rust-scraping rings and the reverse rust-scraping rings are opposite to each other, the forward scrapers and the reverse scrapers are able to produce axial force components in same direction to the steel tube, and then the axial force components will push the steel tube to make the material pushing manually more easy and labor-saving.

### BRIEF DESCRIPTION OF THE DRAWINGS

FIG. 1 is a stereoscopic view showing the structural schematic diagram of a descaling apparatus for steel tubes of the building scaffold;

FIG. 2 is a partial view showing the structural schematic diagram of the descaling apparatus for steel tubes of the building scaffold;

FIG. 3 is the enlarged structural diagram of “A” in FIG. 1;

FIG. 4 is the enlarged structural diagram of “B” in FIG. 2;

FIG. 5 is the enlarged structural diagram of “C” in FIG. 2;

FIG. 6 is a partial view showing the structural schematic diagram when the rolling assemblies are not installed on a working table;

FIG. 7 is cross-sectional view showing the structural diagram along “D-D” direction in FIG. 2;

FIG. 8 is the enlarged structural diagram of “E” in FIG. 1;

In figure, a bottom panel 1, a working table 11, supporting bases 12, rolling columns 121, a transmission shaft 13, first driving gears 131, second driving gears 132, a driven pulley 133, lower brackets 14, supporting brackets 15, guiding rails 16, guiding grooves 161, an intermediate shaft 17, intermediate gears 171, a pushing base 2, a base 21, a pushing panel 22, clamping hoops 23, forward rust-scraping rings 3, first breaches 31, first guiding columns 32, forward scrapers 33, guiding sleeves 331, first pretensioned springs 34, forward ring gears 35, reverse rust-scraping rings 4, second breaches 41, guiding columns 42, reverse scrapers 43, guiding sleeves 431, second pretensioned springs 44, reverse ring gears 45, rolling assemblies 5, rolling wheels 51, pin shafts 511, rolling ledges 512, a drive motor 6, a driving pulley 61, a belt 62, lifting brackets 7, upper brackets 71, guiding rods 72, driving gears 63, driving motors 64, transmission plates 7, connection plates 71, guide sleeves 72, pressed springs 73, tightening plates 8, tightening projections 81, locating surfaces 811, guiding surfaces 812.

### DETAILED DESCRIPTION OF THE INVENTION

The technical scheme of the invention is further described by the embodiments of the invention not limiting the scope and spirit of the invention in combination with accompanying figures.

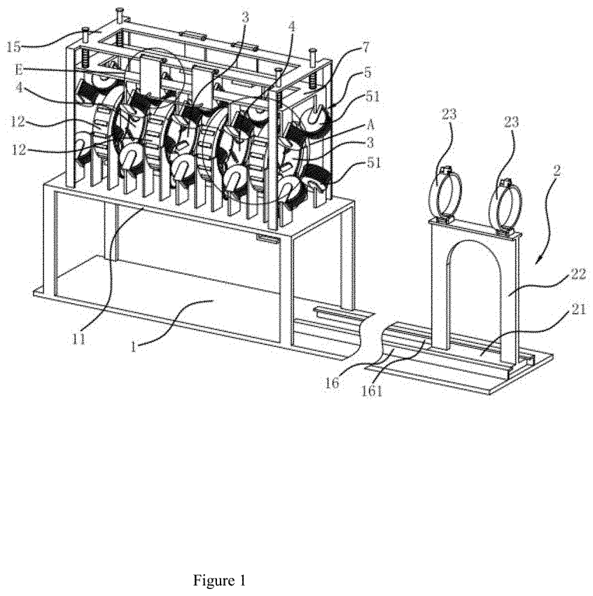

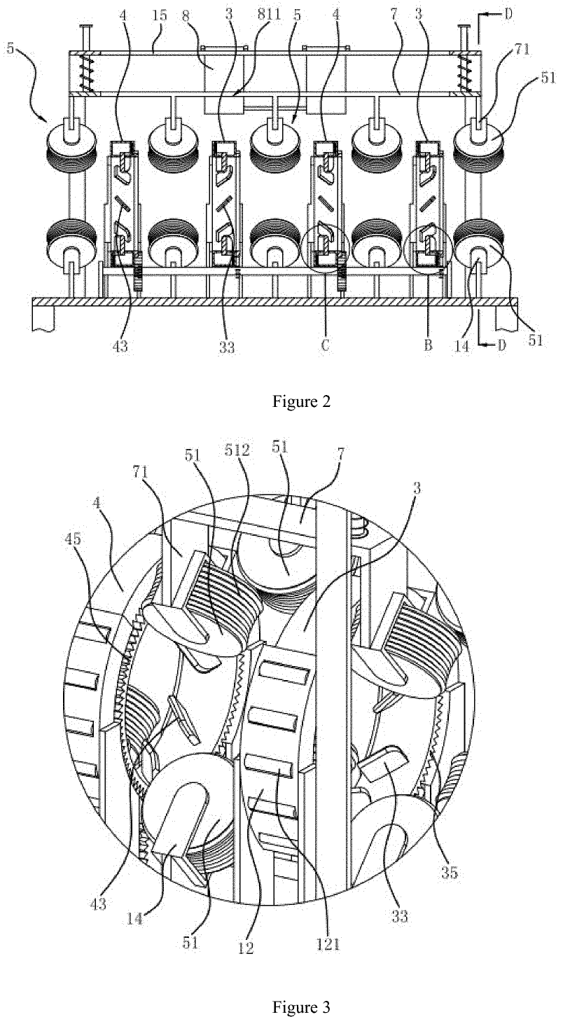

Referring to FIGS. 1, 2 and 3, a descaling apparatus for steel tubes of the building scaffold, comprises a bottom panel 1 extending in an elongate form and a working table 11 fixed on one end of the bottom panel 1, wherein a pushing base 2 for clamping one end of a locating steel tube is slidably arranged on the bottom panel 1 along a length direction, wherein the pushing base 2 comprises a base 21 and a pushing panel 22 vertically fixed on the base 21, wherein a plate surface of the pushing panel 22 is arranged along the length direction of the bottom panel 1, and two of clamping hoops 23 for clamping the steel tubes are disposed on an upper edge of the pushing panel 22, and two of guiding grooves 161 are fixed on one side surface of the bottom panel 1 along the length direction, wherein the guiding grooves 161 with opposite openings are disposed on one opposite side of two of guiding rails 16, and several of rollers are hinged on two side edges of the base 21, and the rollers on two sides are respectively arranged in two of the guiding grooves 161; several of forward rust-scraping rings 3 and several of reverse rust-scraping rings 4 are rotatably connected on the working table 11, wherein several of the forward rust-scraping rings 3 and several of the reverse rust-scraping rings 4 are in radial arrangement successively along the length direction of the bottom panel 1, and several of the forward rust-scraping rings 3 are disposed to be coaxial with several of the reverse rust-scraping rings 4, wherein several of forward scrapers 33 are arranged on circumferences of inner side surfaces of the forward rust-scraping rings 3 and several of reverse scrapers 43 are arranged on circumferences of inner side surfaces of the reverse rust-scraping rings 4, wherein one end of each of the forward scrapers 33 and the reverse scrapers 43 are in the radially inward direction and inner end edges of the forward scrapers 33 and the reverse scrapers 43 are cutting edges, and a length direction of the cutting edges of the forward scrapers 33 is inclined to another side relative to center lines of the forward rust-scraping rings 3, and a length direction of the cutting edges of the reverse scrapers 43 is inclined to another side relative to a center line of the reverse rust-scraping rings 4, and a driving member for driving several of the forward rust-scraping rings 3 and several of the reverse rust-scraping rings 4 to rotate reversely and synchronously is arranged on the working table 11, wherein several sets of rolling assemblies 5 are disposed on the working table 11, wherein each set of the rolling assemblies 5 comprises at least two of rolling wheels 51 for abutting against and supporting lower parts of the steel tubes and at least two of the rolling wheels 51 for pressing upper parts of the steel tubes; whereby when rust removal is performed, one end of the steel tube is fixed on the pushing base 2 and another end is placed on the rolling wheels 51 along the length direction of the bottom panel 1, and at this time, another end of the steel tube is in aligned with inner holes of the forward rust-scraping rings 3 and the reverse rust-scraping rings 4, and then the driving member drives the forward rust-scraping rings 3 and the reverse rust-scraping rings 4 to rotate reversely and synchronously, and at the same time, the pushing base 2 is pushed manually to make another end of the steel tube to penetrate through several of the forward rust-scraping rings 3 and the reverse rust-scraping rings 4, and then the cutting edges of the forward scrapers 33 and the reverse scrapers 43 are all abutted against an outer side surface of the steel tube, and then the forward rust-scraping rings 3 and the reverse rust-scraping rings 4 rotate to make the forward scrapers 33 and the reverse scrapers 43 to remove rust on the outer side surface of the steel tube, wherein the rolling wheels 51 of the rolling assemblies 5 are able to crush relative larger rust on the outer side surface of the steel tube, so that the forward scrapers 33 and the reverse scrapers 43 are able to perform following operation; as the forward scrapers 33 and the reverse scrapers 43 are scrap the rust of the steel tube in opposite directions, so the rust on the outer side surface of the steel tube can be scraped down with repeated movement, which achieve a better rust-removing effect, and as the rotation directions of the forward rust-scraping rings 3 and the reverse rust-scraping rings 4 are opposite, so reverse force acting in the circumferential direction to the steel tube from the forward scrapers 33 and the reverse scrapers 43 are produced, so that the above-stated circumferential forces can cancel each other out to avoid a phenomenon of circumferential rotation for the steel tube when rust-removal is performed; at the same time, the steel tube is pushed manually and the forward scrapers 33 and the reverse scrapers 43 are arranged inclined with opposite directions, so under a circumstance that the rotation direction of the forward rust-scraping rings 3 and the reverse rust-scraping rings 4 are opposite to each other, the forward scrapers 33 and the reverse scrapers 43 are able to produce axial force components in same direction to the steel tube, and then the axial force components will push the steel tube to make the material pushing manually more easy and labor-saving.

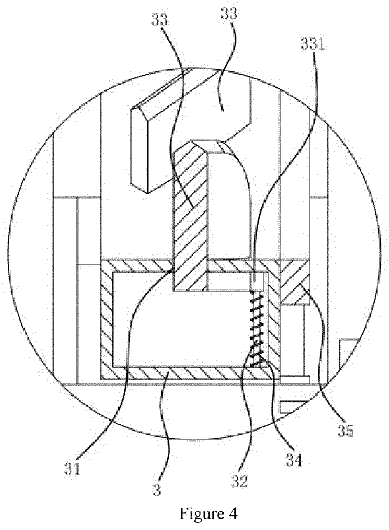

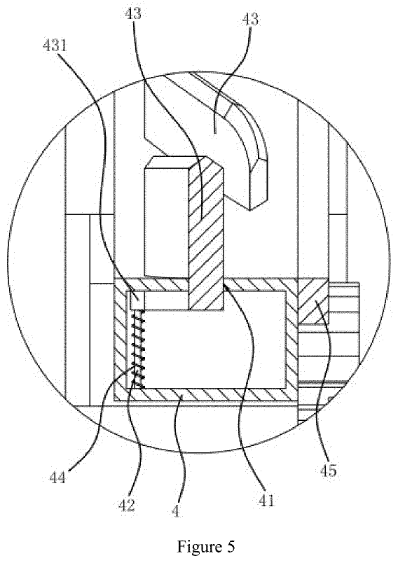

Referring to FIGS. 4 and 5, a first elastic member for making the forward scrapers 33 have a inward protruding tendency is arranged between the forward rust-scraping rings 3 and several of the forward scrapers 33, and second elastic member for making the reverse scrapers 43 have a inward protruding tendency is arranged between the reverse rust-scraping rings 4 and several of the reverse scrapers 43, wherein ends of the cutting edges of several of the forward scrapers 33 and the cutting edges of several of the reverse scrapers 43 facing towards the pushing base 2 are arranged with arc-shaped chamfer, and several sets of the rolling assemblies 5, several of the forward rust-scraping rings 3 and several of the reverse rust-scraping rings 4 are arranged successively at intervals; whereby the first elastic member drives the forward scrapers 33 to press tightly to abut against an outer peripheral surface of the steel tube, and the second elastic member drives the reverse scrapers 43 to press tightly to abut against the outer peripheral surface of the steel tube, and the arc-shaped chamfer will press the forward scrapers 33 and the reverse scrapers 43 more smoothly when driving the ends of the steel tube to penetrate, and several sets of the rolling assemblies 5, several of the forward rust-scraping rings 3 and several of the reverse rust-scraping rings 4 are arranged successively at intervals, which has a better rust-removal effect; the forward rust-scraping rings 3 are in hollow structure, and several of the first breaches 31 extending in the elongate form are defined on inner side surfaces of the forward rust-scraping rings 3 on circumferential direction, wherein several of the forward scrapers 33 extend out of several of the first breaches 31 respectively, and several sets of first guiding columns 32 are fixed on side walls of inner cavities of the forward rust-scraping rings 3, wherein several sets of the first guiding columns 32 are corresponded to several of the forward scrapers 33, and first guiding sleeves 331 are arranged on edges of two sides of the forward scrapers 33, wherein two of the first guiding sleeves 331 are respectively slidably sleeved on two of the first guiding columns 32, wherein the first elastic member is pretensioned springs 34 sleeved on the first guiding columns 32, and one end of each of the pretensioned springs 34 is abutted against a side wall of an inner cavity of corresponding one of the forward rust-scraping rings 3 and another end of each of the pretensioned springs 34 is abutted against end surface of corresponding one of the first guiding sleeves 331 to make the forward scrapers 33 to maintain a stable state; the reverse rust-scraping rings 4 are in hollow structure, several of second breaches 41 extending in the elongate form are defined on an inner side surfaces of the reverse rust-scraping rings 4 on circumferential direction, wherein several of the reverse scrapers 43 extend out of several of the second breaches 41 respectively, and several sets of guiding columns 42 are fixed on side walls of an inner cavities of the reverse rust-scraping rings 4, wherein several sets of the guiding columns 42 are corresponding to several of the reverse scrapers 43, wherein second guiding sleeves 431 are arranged on edges of two sides of the reverse scrapers 43, wherein two of the second guiding sleeves 431 are respectively and slidably sleeved on two of the guiding columns 42, wherein the second elastic member is pretensioned springs 44 sleeved on the guiding columns 42, wherein one end of each of the pretensioned springs 44 is abutted against the side wall of the cavity of corresponding one of the reverse rust-scraping rings 4 and another end of each of the pretensioned springs 44 is abutted against the end surface of corresponding one of the second guiding sleeves 431 to make the reverse scrapers 43 to maintain a stable state.

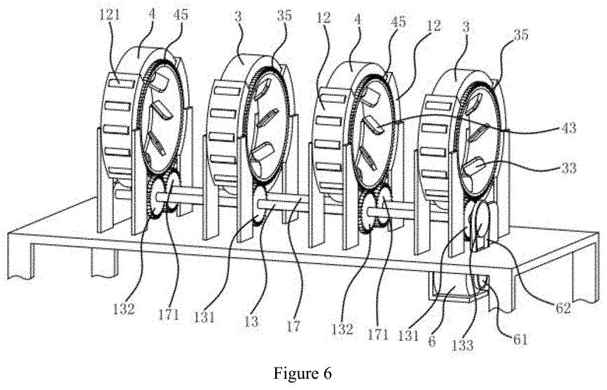

Referring to FIG. 6, several sets of supporting bases 12 on bar plate shape are fixed on the working table 11, wherein the supporting bases 12 on arc-shaped and cross sections of the supporting bases 12 are on U-shaped, and two of the supporting bases 12 of the same pair have opposite notches, and several of rolling columns 121 are rotatably connected on bottom surfaces of the supporting bases 12, wherein length directions of the rolling columns 121 are the same as that of the bottom panel 1, and the forward rust-scraping rings 3 and the reverse rust-scraping rings 4 are respectively embedded into several sets of the supporting bases 12, and outer side surfaces of the forward rust-scraping rings 3 and the reverse rust-scraping rings 4 are respectively abutted against peripheral surfaces of several of the rolling columns 121, and the supporting bases 12 are able to guide and support the forward rust-scraping rings 3 and the reverse rust-scraping rings 4 to ensure a smooth rotation; the driving member comprises a drive motor 6, a transmission shaft 13 and an intermediate shaft 17 are rotatably connected on the working table 11, wherein the transmission shaft 13 and the intermediate shaft 17 are arranged along the length direction of the bottom panel 1, wherein several of first driving gears 131 and several of the second driving gears 132 are fixed on the transmission shaft 13 along the length direction, wherein several of the first driving gears 131 and several of the second driving gears 132 are arranged at intervals, and several of intermediate gears 171 are fixed on the intermediate shaft 17, and forward ring gears 35 are fixed on the end surfaces of the forward rust-scraping rings 3, and the reverse ring gears 45 are fixed on the end surfaces of the reverse rust-scraping rings 4, wherein several of the first driving gears 131 are engaged with several of the forward ring gears 35, and each of the second driving gears 132 and the corresponding one of the reverse ring gears 45 are arranged in axially staggered relation, wherein several of the second driving gears 132 are engaged with several of the intermediate gears 171, and each of the intermediate gears 171 is engaged with the corresponding one of the reverse ring gears 45, and a driving pulley 61 is fixed on a motor shaft of the drive motor 6, and a driven pulley 133 is fixed on the transmission shaft 13, wherein the driving pulley 61 is connected with the driven pulley 133 by a belt 62, and the transmission shaft 13 drives the forward rust-scraping rings 3 to rotate forwardly through a cooperation of the first driving gears 131 and the forward ring gears 35, and a thickness of the intermediate gears 171 is twice as thick as that of the second driving gears 132 and the reverse ring gears 45, so that the intermediate gears 171 can be engaged with the second driving gears 132 and the reverse ring gears 45 at the same time; whereby the transmission shaft 13 drives the reverse rust-scraping rings 4 to rotate reversely through the second driving gears 132, the intermediate gears 171 and the reverse ring gears 45.

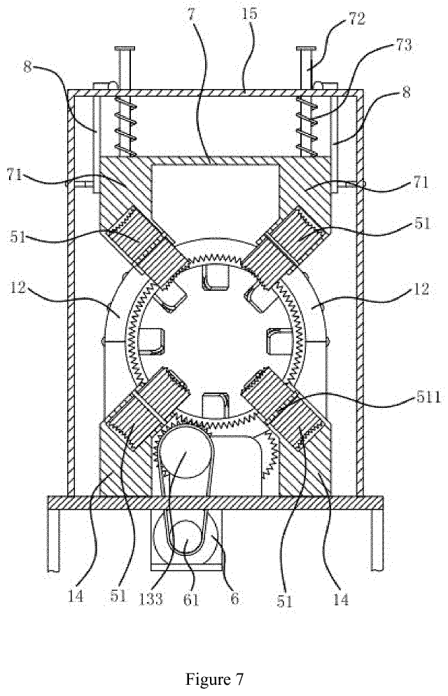

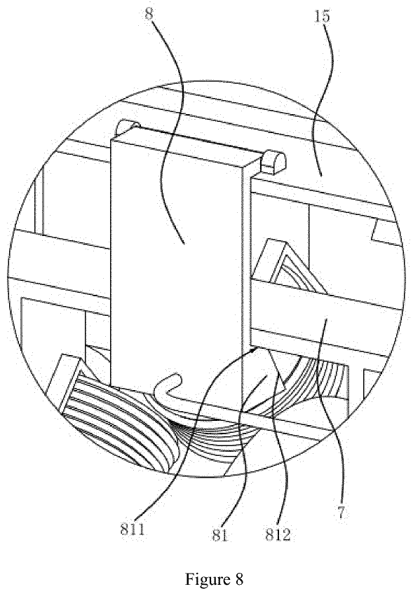

Referring to FIGS. 7 and 8, the rolling assemblies 5 further comprise upper brackets 71 and lower brackets 14, wherein the lower brackets 14 are fixed on the working table 11, wherein two of the rolling wheels 51 are rotatably connected on the lower brackets 14 through pin shafts 511, wherein two of the pin shafts 511 are perpendicular to the length direction of the bottom panel 1, and a distance between two of the pin shafts 511 are becoming larger gradually with height, lifting brackets 7 are slidably and vertically connected on the working table 11, wherein upper brackets 71 are fixed on the lifting brackets 7, and two of the rolling wheels 51 are rotatably connected on the upper brackets 71 through the pin shafts 511, wherein two of the rolling wheels 51 are perpendicular to the length direction of the bottom panel 1, and a distance between two of the pin shafts 511 are becoming larger gradually with height, and two of the rolling wheels 51 below are performing a supporting function to the steel tube while two of the rolling wheels 51 above are performing a pressing function, and so that four of the rolling wheels 51 are able to crush the outer side surface of the steel tube, and supporting brackets 15 are fixed on the working table 11, wherein several of guiding holes are defined on the supporting brackets 15, and several of guiding rods 72 are vertically fixed on upper side surfaces of lifting brackets 7, wherein several of the guiding rods 72 are slide upward respectively to pass through several of the guiding holes, wherein each of pressed springs 73 is sleeved on each of the guiding rods 72, and upper ends of the pressed springs 73 act on lower side surfaces of the supporting brackets 15 while lower ends of the pressed springs 73 act on the upper side surfaces of the lifting brackets 7, and tightening plates 8 are hinged on edges of two sides of the supporting brackets 15, wherein tightening projections 81 are arranged on side surfaces of free ends of the tightening plates 8, wherein locating surfaces 811 of flat and guiding surfaces 812 of arc-shaped are respectively disposed on the tightening projections 81; whereby the tightening plates 8 swing downward to push the lifting brackets 7 by the guiding surfaces 812, and then when the tightening plates 8 are vertically downward, the locating surfaces 811 are able to stick to and abutted against lower side surfaces of the lifting brackets 7; the pressed springs 73 are able to drive the rolling wheels 51 to press tightly on the peripheral surface of the steel tube, and after the rust-removal is finished, the tightening plates 8 swing downward, and then the guiding surfaces 812 on the tightening projections 81 are able to push the lifting brackets 7 upward until the locating surfaces 811 are horizontally and abutted against the lower side surfaces of the lifting brackets 7, so that two of the rolling wheels 51 on top separate from the steel tube for a convenient loading and unloading of the steel tube; several of rolling ledges 512 of annular are arranged on wheel surfaces of the rolling wheels 51 on the circumferential direction, wherein several of the rolling ledges 512 are in a radial arrangement successively along the axial direction, and cross sections of the rolling ledges 512 are on angle shape, wherein the rolling ledges 512 are able to better crush the rust on outer side surface of the steel tube, so that the rust are crushed into pieces or peeled off to improve a rust-removal effect.

1. A descaling apparatus for steel tubes of the building scaffold, comprising:
a bottom panel extending in an elongate form;
a working table fixed on one end of the bottom panel,
wherein a pushing base for clamping one end of a locating steel tube is slidably arranged on the bottom panel along a length direction, and several of forward rust-scraping rings and several of reverse rust-scraping rings are rotatably connected on the working table,
wherein several of the forward rust-scraping rings and several of the reverse rust-scraping rings are in radial arrangement successively along the length direction of the bottom panel, and several of the forward rust-scraping rings are disposed to be coaxial with several of the reverse rust-scraping rings,
wherein several of forward scrapers are arranged on circumferences of inner side surfaces of the forward rust-scraping rings and several of reverse scrapers are arranged on circumferences of inner side surfaces of the reverse rust-scraping rings,
wherein one end of each of the forward scrapers and the reverse scrapers are in the radially inward direction and inner end edges of the forward scrapers and the reverse scrapers are cutting edges, and a length direction of the cutting edges of the forward scrapers is inclined to another side relative to center lines of the forward rust-scraping rings, and a length direction of the cutting edges of the reverse scrapers is inclined to another side relative to a center line of the reverse rust-scraping rings;
a driving member for driving several of the forward rust-scraping rings and several of the reverse rust-scraping rings to rotate reversely and synchronously arranged on the working table,
wherein several sets of rolling assemblies are disposed on the working table,
wherein each set of the rolling assemblies comprises at least two of rolling wheels for abutting against and supporting lower parts of the steel tubes and at least two of the rolling wheels for pressing upper parts of the steel tubes.

2. The descaling apparatus for steel tubes of the building scaffold defined in claim 1, wherein a first elastic member for making the forward scrapers have a inward protruding tendency is arranged between the forward rust-scraping rings and several of the forward scrapers;
second elastic member for making the reverse scrapers have a inward protruding tendency arranged between the reverse rust-scraping rings and several of the reverse scrapers,
wherein ends of the cutting edges of several of the forward scrapers and the cutting edges of several of the reverse scrapers facing towards the pushing base are arranged with arc-shaped chamfer, and several sets of the rolling assemblies, several of the forward rust-scraping rings and several of the reverse rust-scraping rings are arranged successively at intervals.

3. The descaling apparatus for steel tubes of the building scaffold defined in claim 2, wherein the forward rust-scraping rings are in hollow structure;
several of the first breaches which is extending in the elongate form defined on inner side surfaces of the forward rust-scraping rings on circumferential direction,
wherein several of the forward scrapers extend out of several of the first breaches respectively, and several sets of first guiding columns are fixed on side walls of inner cavities of the forward rust-scraping rings,
wherein several sets of the first guiding columns are corresponded to several of the forward scrapers, and first guiding sleeves are arranged on edges of two sides of the forward scrapers,
wherein two of the first guiding sleeves are respectively slidably sleeved on two of the first guiding columns,
wherein the first elastic member is pretensioned springs sleeved on the first guiding columns, and one end of each of the pretensioned springs is abutted against a side wall of an inner cavity of corresponding one of the forward rust-scraping rings and another end of each of the pretensioned springs is abutted against end surface of corresponding one of the first guiding sleeves.

4. The descaling apparatus for steel tubes of the building scaffold defined in claim 3, wherein the reverse rust-scraping rings are in hollow structure;
several of second breaches which is extending in the elongate form defined on an inner side surfaces of the reverse rust-scraping rings on circumferential direction,
wherein several of the reverse scrapers extend out of several of the second breaches respectively, and several sets of guiding columns are fixed on side walls of an inner cavities of the reverse rust-scraping rings,
wherein several sets of the guiding columns are corresponding to several of the reverse scrapers,
wherein second guiding sleeves are arranged on edges of two sides of the reverse scrapers,
wherein two of the second guiding sleeves are respectively and slidably sleeved on two of the guiding columns,
wherein the second elastic member is pretensioned springs sleeved on the guiding columns, wherein one end of each of the pretensioned springs is abutted against the side wall of the cavity of corresponding one of the reverse rust-scraping rings and another end of each of the pretensioned springs is abutted against the end surface of corresponding one of the second guiding sleeves.

5. The descaling apparatus for steel tubes of the building scaffold defined in claim 4, wherein several sets of supporting bases on bar plate shape are fixed on the working table,
wherein the supporting bases on arc-shaped and cross sections of the supporting bases are on U-shaped, and two of the supporting bases of the same pair have opposite notches;
several of rolling columns rotatably connected on bottom surfaces of the supporting bases,
wherein length directions of the rolling columns are the same as that of the bottom panel, and the forward rust-scraping rings and the reverse rust-scraping rings are respectively embedded into several sets of the supporting bases, and outer side surfaces of the forward rust-scraping rings and the reverse rust-scraping rings are respectively abutted against peripheral surfaces of several of the rolling columns.

6. The descaling apparatus for steel tubes of the building scaffold defined in claim 5, wherein the driving member comprises a drive motor, a transmission shaft and an intermediate shaft are rotatably connected on the working table,
wherein the transmission shaft and the intermediate shaft are arranged along the length direction of the bottom panel,
wherein several of first driving gears and several of the second driving gears are fixed on the transmission shaft along the length direction,
wherein several of the first driving gears and several of the second driving gears are arranged at intervals, and several of intermediate gears are fixed on the intermediate shaft, and forward ring gears are fixed on the end surfaces of the forward rust-scraping rings, and the reverse ring gears are fixed on the end surfaces of the reverse rust-scraping rings,
wherein several of the first driving gears are engaged with several of the forward ring gears, and each of the second driving gears and the corresponding one of the reverse ring gears are arranged in axially staggered relation,
wherein several of the second driving gears are engaged with several of the intermediate gears, and each of the intermediate gears is engaged with the corresponding one of the reverse ring gears;
a driving pulley fixed on a motor shaft of the drive motor;
a driven pulley fixed on the transmission shaft,
wherein the driving pulley is connected with the driven pulley by a belt.

7. The descaling apparatus for steel tubes of the building scaffold defined in claim 6, wherein the rolling assemblies further comprise upper brackets and lower brackets,
wherein the lower brackets are fixed on the working table,
wherein two of the rolling wheels are rotatably connected on the lower brackets through pin shafts,
wherein two of the pin shafts are perpendicular to the length direction of the bottom panel, and a distance between two of the pin shafts are becoming larger gradually with height;
lifting brackets slidably and vertically connected on the working table,
wherein upper brackets are fixed on the lifting brackets, and two of the rolling wheels are rotatably connected on the upper brackets through the pin shafts,
wherein two of the rolling wheels are perpendicular to the length direction of the bottom panel, and a distance between two of the pin shafts are becoming larger gradually with height.

8. The descaling apparatus for steel tubes of the building scaffold defined in claim 7, wherein supporting brackets are fixed on the working table,
wherein several of guiding holes are defined on the supporting brackets, and several of guiding rods are vertically fixed on upper side surfaces of lifting brackets,
wherein several of the guiding rods are slide upward respectively to pass through several of the guiding holes,
wherein each of pressed springs is sleeved on each of the guiding rods, and upper ends of the pressed springs act on lower side surfaces of the supporting brackets while lower ends of the pressed springs act on the upper side surfaces of the lifting brackets;
tightening plates hinged on edges of two sides of the supporting brackets,
wherein tightening projections are arranged on side surfaces of free ends of the tightening plates,
wherein locating surfaces of flat and guiding surfaces of arc-shaped are respectively disposed on the tightening projections;
whereby the tightening plates swing downward to push the lifting brackets by the guiding surfaces, and then when the tightening plates are vertically downward, the locating surfaces are able to stick to and abutted against lower side surfaces of the lifting brackets.

9. The descaling apparatus for steel tubes of the building scaffold defined in claim 7, several of rolling ledges of annular are arranged on wheel surfaces of the rolling wheels on the circumferential direction,
wherein several of the rolling ledges are in a radial arrangement successively along the axial direction, and cross sections of the rolling ledges are on angle shape.

10. The descaling apparatus for steel tubes of the building scaffold defined in claim 5, wherein the pushing base comprises the base and a pushing panel vertically fixed on the base,
wherein a plate surface of the pushing panel is arranged along the length direction of the bottom panel, and two of clamping hoops for clamping the steel tubes are disposed on an upper edge of the pushing panel, and two of guiding grooves are fixed on one side surface of the bottom panel along the length direction,
wherein the guiding grooves with opposite openings are disposed on one opposite side of two of guiding rails, and several of rollers are hinged on two side edges of the base, and the rollers on two sides are respectively arranged in two of the guiding grooves.
